(19) United States
(12) Patent Application Publication
(10) Pub. No.: US 2003/0209824 A1
(43) Pub. Date: Nov. 13, 2003

(54) Injection unit of an injection molding machine and control method thereof

(75) Inventors: Jun Koike, Shizuoka-ken (JP); Katsuhito Ogura, Numazu-shi (JP); Yoshinori Nakanishi, Numazu-shi (JP); Harumichi Tokuyama, Odawara-shi (JP); Katsuyoshi Kido, Numazu-shi (JP)

Correspondence Address: PILLSBURY WINTHROP, LLP, P.O. BOX 10500, MCLEAN, VA, 22102, US

(73) Assignee: TOSHIBA MACHINE CO., LTD., Tokyo (JP)

(21) Appl. No.: 10/431,608

(22) Filed: May 8, 2003

(30) Foreign Application Priority Data
May 8, 2002 (JP) 2002-133141

(51) Int. Cl. B29C 45/76; B29C 45/50

(52) U.S. Cl. 264/40.1; 425/135; 425/542

(57) ABSTRACT

A screw is installed in a heating barrel. The rear end of the screw is supported by an intermediate plate via a bearing. The servomotor for charging is connected to a near the rear end of the screw. To the back surface of the intermediate plate, a direct current linear motor for injection is connected via a load cell. The load cell detects the axial direction load applied to the rear end of the screw by the pressure of the molten resin in the heating barrel during charging, and also detects the axial direction load applied to the rear end of the screw for moving the screw forward during injection. The current to be supplied to the DC linear motor is controlled in a feedback manner based on the detected axial direction load, thereby bringing the pressure of the molten resin in the heating barrel closer to a predetermined pattern.

### CROSS-REFERENCE TO RELATED APPLICATIONS

This application is based upon and claims the benefit of priority from the prior Japanese Patent Application No. 2002-133141, filed May 8, 2002, the entire contents of which are incorporated herein by reference.

### BACKGROUND OF THE INVENTION

1. Field of the Invention

The present invention relates to an injection unit of an injection molding machine, and more specifically to a structure of the injection unit using a linear motor as a driving source for moving a screw forward within a heating barrel.

2. Description of the Related Art

FIG. 4 shows a schematic view of the injection unit of an electric injection molding machine using a linear motor as a driving source for injection.

A screw 5 is installed in a heating barrel 3. The rear end of the screw 5 is supported by an intermediate plate 6 via a bearing. A servomotor 7 for use in charging is mounted on the intermediate plate 6. The driving shaft of the servomotor 7 is connected to a portion near the rear end of the screw 5. To the back surface of the intermediate plate 6, a linear motor 19 for use in injection is connected.

In charging, the screw 5 is rotated in the forward direction by the servomotor 7 within the heating barrel 3, thereby introducing a raw material resin from a hopper 4 into the heating barrel 3. The raw material resin thus introduced is stirred, heated and melted in the heating barrel 3, and sent to a portion ahead of the screw 5. With this movement, the screw 5 is gradually moved back by the pressure of the molten resin, with the result that the molten resin is accumulated in the tip of the heating barrel 3. After a predetermined amount of molten resin is accumulated, the screw 5 is moved forward by the linear motor 19. In this way, a dies 1 is charged with the molten resin.

When high-speed injection is required by use of the electric injection molding machine, an alternating current linear motor (AC linear motor) is generally used as a driving source for use in injection. However, the AC linear motor has a problem in that large magnetic attraction force is applied to the motor. Because of this problem, the AC linear motor must have a mechanically strong structure sufficient to withstand the large attraction force, for example, by increasing the mechanical strength of the housing installing the motor, designing the housing such that the magnetic attraction forces are mutually cancelled out, or multiplying the structure of the motor itself to mitigate the influence of the magnetic attraction force. As a result, the time and labor to design the driving unit for injection increases, raising the manufacturing cost.

In addition, to control the thrust of the AC linear motor, a magnetic pole must be detected. Accordingly, a magnetic pole detector and a position detector must be provided. By the presence of both detectors, the control system becomes complicated. Furthermore, when the detection accuracy of a magnetic pole is low, the efficiency and accuracy of control operation degrade. Therefore, the position for detecting the magnetic pole must be accurately adjusted. If so, it will be difficult to assemble the injection unit and perform initial adjustment thereof.

Moreover, since it is not easy to modify the magnetic-circuit arrangement of the AC linear motor, the thrust of the AC linear motor per unit volume is relatively low. Therefore, when large thrust is required, an AC linear motor having large outer dimensions is used. The AC linear motor of large outer dimensions is generally of three phases type and operated in accordance with three-phase control. The three-phase control is more complicated than a single-phase control and requires much arithmetic work. In the three-phase control, since current is controlled separately in individual phases, driving circuits corresponding to the three phases are required. As a result, the motor driver becomes larger in the three-phase control than in the single-phase control. Furthermore, the three-phase motor requires wiring for the three phases, with the result that the amount of wiring is larger than that of the single-phase motor.

As described above, when the AC linear motor is used as a driving source for injection, the structure and controlling manner of the injection unit must be designed properly in consideration of specific characteristics of the AC linear motor.

### BRIEF SUMMARY OF THE INVENTION

The present invention has been conceived in view of solving the problems of the injection unit of a conventional electric injection molding machine. An object of the present invention is to provide an injection unit with a control system having a relatively small and simple driving source.

An injection unit of an injection molding machine of the present invention comprises:

a heating barrel;

a screw installed in the heating barrel, a resin being introduced into the heating barrel by rotating the screw and melted, and then injected into dies by moving the screw forward;

a direct current linear motor which drives the screw in axial direction;

a load cell which measures axial direction load applied to the screw; and

a control unit which controls current to be supplied to the direct current linear motor based on the output from the load cell such that the axial direction load is set at a predetermined value.

According to the injection unit of the injection molding machine of the present invention, the driving force of the DC linear motor is directly controlled based on the measurement value of the axial direction load applied to the screw. As a result, it is possible to accurately control the pressure of the molten resin within the heating barrel during charging, injection, and pressure holding after the injection step.

### BRIEF DESCRIPTION OF THE SEVERAL VIEWS OF THE DRAWING

FIG. 1 shows a schematic view of an injection unit of an injection molding machine according to the present invention;

FIG. 2 is a configuration of a control system of the injection unit according to the present invention;

FIG. 3 is a configuration of a control system of a comparative example using an AC linear motor as a driving source for injection; and

FIG. 4 is a schematic view of an injection unit of a conventional injection molding machine using a linear motor as a driving source.

### DETAILED DESCRIPTION OF THE INVENTION

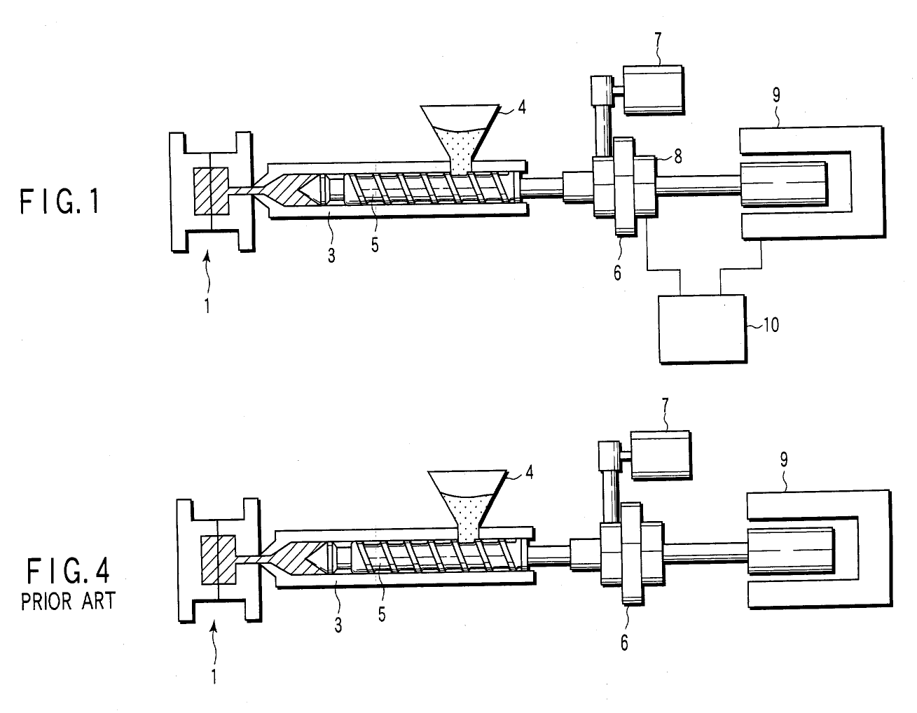

FIG. 1 shows a schematic structure of an injection unit of an injection molding machine of the present invention. In the figure, reference numeral 1 denotes dies, 3 a heating barrel, 5 a screw, 7 a servomotor for charging, 9 a DC linear motor for injection, and 10 a control unit.

The screw 5 is installed in the heating barrel 3. To a portion near the rear end of the heating barrel 3, a hopper 4 is connected. The rear end of the screw 5 is supported by an intermediate plate 6 via a bearing. On the intermediate plate 6, a servomotor 7 for charging is mounted. The driving shaft of the servomotor 7 is connected to a portion near the rear end of the screw 5 by way of pulleys and a timing belt. To the back surface of the intermediate plate 6, a DC linear motor 9 for injection is connected via a load cell 8.

In charging, the screw 5 is rotated by the servomotor 7 in the forward direction in the heating barrel 3 to introduce a raw material resin from the hopper 4 into the heating barrel 3. The raw material resin thus introduced is stirred, heated and melted in the heating barrel 3, and sent to a portion ahead of the screw 5. With this movement, the screw 5 is gradually moved back by the pressure of the molten resin, with the result that the molten resin is accumulated in the tip of the heating barrel 3.

After a predetermined amount of molten resin is accumulated in the heating barrel 3, the screw 5 is moved forward by use of the DC linear motor 9, thereby injecting the molten resin into the cavity of the dies 1. After the dies 1 is charged with the molten resin, thrust is continuously applied for a predetermined time so as to keep the inner pressure of the heating barrel 3 constant. In this manner, the molten resin corresponding to the amount of shrinkage due to solidification, is supplied to the dies 1.

The load cell 8 detects the axial direction load (back pressure of the screw) applied to the rear end of the screw 5 by the pressure of the molten resin stored in the tip of the heating barrel 3 during charging, and also detects the axial direction load applied to the rear end of the screw 5 for moving the screw 5 forward during injection. Furthermore, the pressure of the resin in the heating barrel 3 during pressure holding after the injection step is detected by the load cell 8.

The output from the load cell 8 is sent to the control unit 10, which controls the current to be supplied to the DC linear motor 9 in a feedback manner based on the output to bring the pressure of the molten resin within the heating barrel 3 closer to a predetermined pattern.

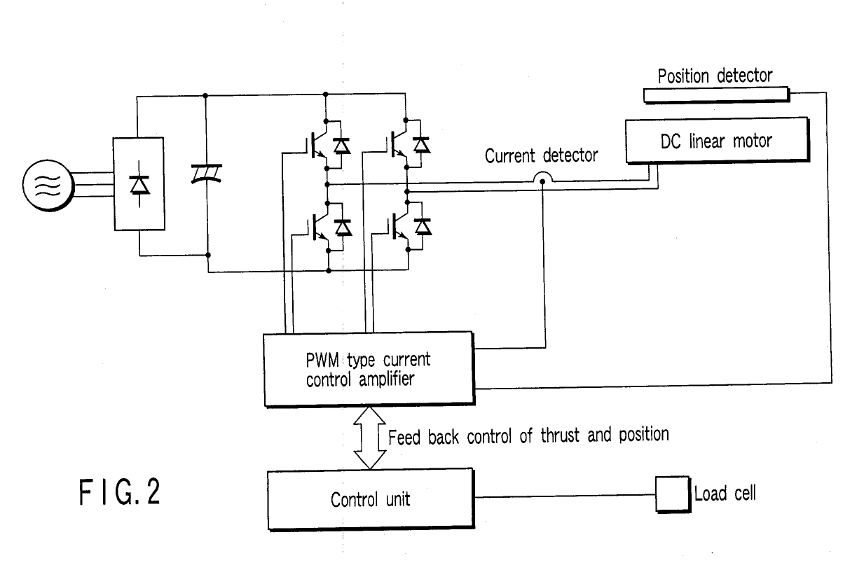

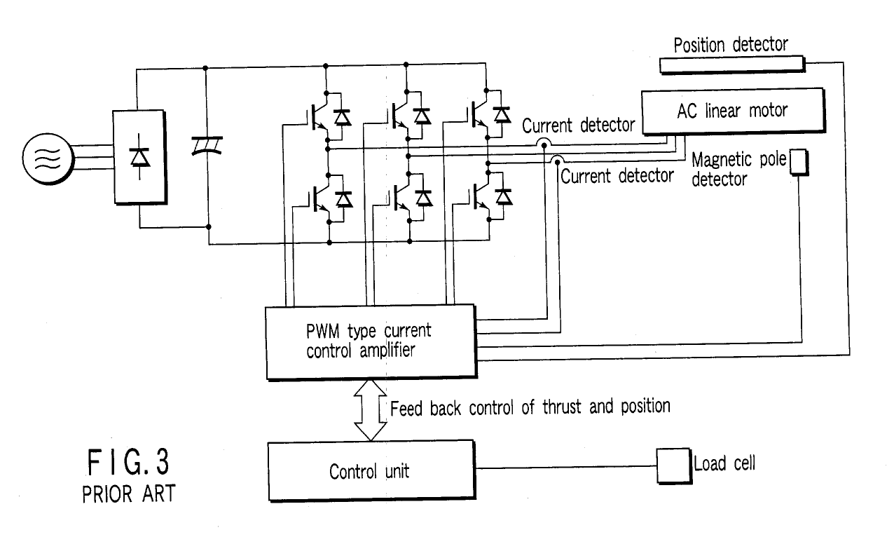

FIG. 2 shows a schematic view of a control system using the DC linear motor as a driving source for use in injection operation, according to the present invention. FIG. 3 shows a schematic view of a control system of a comparative example using a three-phase AC linear motor as a driving source for use in injection operation. Since the DC linear motor is of single phase type, a single-phase control is applied. The DC linear motor requires no magnetic pole detector and only a fewer number of current detectors. In addition, a smaller motor driver is used. Therefore, the control system becomes simple.

Note that when a voice-coil type linear motor is employed as the DC linear motor, it is theoretically possible to eliminate the magnetic attraction force the linear motor itself and therefore the structure can be simplified. Furthermore, when a twin-type DC linear motor (in which a pair of voice-coil type DC linear motors are arranged such that thrusts act in the same direction and the magnetic fields are generated in the opposite direction) is employed, thrust per unit area can be increased and the outer dimensions of the motor can be reduced.

According to the injection unit of the injection molding machine of the present invention, a driving source for injection can be reduced in size and the configuration of the control system can be simplified. Furthermore, according to the injection unit of the injection molding machine of the present invention, a resin pressure of the heating barrel can be accurately controlled during charging, injection and pressure-holding after the injection step.

What is claimed is:

1. An injection unit of an injection molding machine comprising:
a heating barrel;
a screw installed in the heating barrel, a resin being introduced into the heating barrel by rotating the screw and melted therein, and then injected into a cavity of dies by moving the screw forward;
a direct current linear motor which drives the screw in axial direction;
a load cell which measures axial direction load applied to the screw; and
a control unit which controls current to be supplied to the direct current linear motor based on the output from the load cell such that the axial direction load is set at a predetermined value.

2. A method of controlling an injection unit of an injection molding machine, said injection molding machine comprising:
a heating barrel;
a screw installed in the heating barrel, a resin being introduced into the heating barrel by rotating the screw and melted therein, and injected into a cavity of dies by moving the screw forward; and
a direct current linear motor which drives the screw in axial direction;
said method comprising:
measuring axial direction load applied to the screw; and
controlling current to be supplied to the direct current linear motor based on the measurement results such that the axial direction load is set at a predetermined value.
